(19) United States
(12) Patent Application Publication
(10) Pub. No.: US 2023/0166137 A1
(43) Pub. Date: Jun. 1, 2023

(54) Safety Line System and Anchor Device

(71) Applicant: Latchways plc, Devizes (GB)

(72) Inventor: Jacob Thackeray Squire, Devizes (GB)

(21) Appl. No.: 17/922,003

(22) PCT Filed: Apr. 23, 2021
(86) PCT No.: PCT/GB2021/050986

§ 371 Date: Oct. 28, 2022

(30) Foreign Application Priority Data
May 1, 2020 (GB) 2006466.3

(51) Int. Cl. A62B 35/00

(52) U.S. Cl. CPC A62B 35/0068; A62B 35/0056

(57) ABSTRACT

A safety line anchor device with a first component, the first component having a connection part at first end and a gripping element at a second end, a second component, the second component having a first opposed end portion, a second end portion, and a pin fixed in position and protruding from the second component, and the first component is slidably mounted to the second component and the gripping element separates the first opposed end portion and the second end portion.

### CROSS-REFERENCE TO RELATED APPLICATION

This application is a U.S. National Stage Application under 35 U.S.C. § 371 of International Patent Application No. PCT/GB2021/050986, filed Apr. 23, 2021, which claims priority to United Kingdom Patent Application No. 2006466.3 filed May 1, 2020, the both of which are incorporated by reference in their entireties.

### BACKGROUND

### Technical Field

The present disclosure relates to a safety line system and anchor device, and in non-limiting embodiments or aspects, to a safety line system including an intermediate safety line anchor device as used for height safety apparatuses, such as lifelines or safety lines extending between fixed anchor points.

### Technical Considerations

In height safety applications, such as for example working on a building roof, it is common for a safety apparatus to be provided that includes a horizontally orientated safety line to which an operative is secured by means of a harness connected tether. In order to move along the roof while connected to the horizontally orientated safety line, a traveller is provided for the tether which permits the harness connected tether to move along the horizontally orientated safety line. Exemplary arrangements are disclosed, for example, in WO2011/027109 and GB2420820. Once secured to the safety line, the traveller cannot be removed without deliberate action to release the traveller by the operative.

A risk associated with a fall in such an environment is that if the operative falls over the edge of a building, the tether can slide against the building edge resulting in the edge cutting or sawing into the tether, with the associated risk of rupturing or snapping the tether and the operative falling to serious injury or death.

A particular risk occurs where a temporary horizontal safety line is secured between makeshift anchor points on a building roof, for example. In such a situation, if the span between the secured anchored ends of the lifeline is too long then a fall can result in a lateral deflection of the safety line to such an extent that the user may fall over the edge of the building. The disclosure seeks to provide an intermediate (temporary) anchor arrangement to avoid the possibility of such an over-long safety line span between anchor points.

### SUMMARY

An improved safety line traveller arrangement has now been devised.

In some non-limiting embodiments or aspects, a safety line anchor device may be arranged to constrain a safety line in order to anchor the safety line to a structure. The anchor device may include a reconfigurable constraining arrangement or body, which is reconfigurable to a gripping configuration, in which the safety line is gripped by the constraining arrangement, from a non-gripped configuration in which the safety line is constrained by the constraining arrangement, but not gripped.

In some non-limiting embodiments or aspects, the constraining arrangement or body may include a first component arranged to constrain the safety line, the first component being coupled with a second component which is arranged to be movable with respect to the first component so as to be deployed to grip the safety line. In some non-limiting embodiments or aspects, the first and second components may be normally held in the configuration in which the safety line is constrained by the constraining arrangement, but not gripped. The first and second components, in some non-limiting embodiments or aspects, may be preferably caused to reconfigure to the gripped configuration in the event of a force acting on one of the components. The first and second components may move relative to one another translationally (linearly) between the non-gripping and gripping configurations in some non-limiting embodiments or aspects.

A guide arrangement, in some non-limiting embodiments or aspects, may be preferably provided to guide the components to move between the non-gripping and gripping configurations. The guide arrangement, in some non-limiting embodiments or aspects, may include a slot provided for one of the components and a slider structure (for example a pin) carried by the other of the components for guided movement along the slot. One of the components of the constraining arrangement or body, in some non-limiting embodiments or aspects, may have a gripping surface and before deployment from the non-gripping configuration to the gripping configuration, the gripping surface may be held abeyance from the safety line.

The device, in some non-limiting embodiments or aspects, may include a connection element for connection to a tether, karabiner, or another connection element. The connection element, in some non-limiting embodiments or aspects, may be provided on a component that includes a gripping surface to grip the safety line. In some non-limiting embodiments or aspects, the constraining arrangement or body may include a curved structure tapering from a relatively broad root portion to a narrower tip portion, the curved structure defining a boundary around a space within which the diameter of the safety line is received, in use.

In some non-limiting embodiments or aspects, one of the components including the constraining body may be mounted within the longitudinal extent of the other component such that it is bounded at either end by the other of the components. In some non-limiting embodiments or aspects, the shape and configuration of the constraining arrangement may be such that a nesting space is dimensioned to accommodate a like shaped and dimensioned traveller, in an inverted position, in the nesting space. The nesting space, in some non-limiting embodiments or aspects, may be defined by one (or both) of the first and second components which has a curved structure tapering from a relatively broad root portion to a narrower tip portion.

A safety line system may include, in some non-limiting embodiments or aspects, an anchor device having a connection formation for securing to an anchor point, and a nesting space which is defined by a component which has a curved/curled structure tapering from a relatively broad root portion to a narrower tip portion; a safety line traveller having a safety line encompassing structure which is shaped and configured complementarily to the curved/curled component of the anchor device, such that the traveller can pass through the nesting space of the anchor device.

An intermediate anchor system for a height safety application may have an anchor device as defined herein, and means for connecting the anchor device to a pre-existing structure are also disclosed herein in accordance with some non-limiting embodiments or aspects.

In some non-limiting embodiments or aspects, a safety line anchor may be configured for constraining an intermediate portion of a safety line. In some non-limiting embodiments or aspects, the safety line anchor may have a constraining body with a first component configured to encompass the safety line and a second component slidably mounted relative to the first component. The first component may be movable relative to the second component between a gripped configuration, which the first component is configured to grip the safety line, and an ungripped configuration, which the first component is released from gripping the safety line.

In some non-limiting embodiments or aspects, the first component may be normally held in the ungripped configuration. In some non-limiting embodiments or aspects, the first component may be configured to move relative to the second component from the ungripped configuration to the gripped configuration in response to a force applied to the safety line.

In some non-limiting embodiments or aspects, the first component may move linearly relative to the second component between the ungripped configuration and the gripped configuration. In some non-limiting embodiments or aspects, a guide arrangement may be configured for guiding a movement of the first component relative to the second component between the ungripped configuration and the gripped configuration.

In some non-limiting embodiments or aspects, the guide arrangement may include a pin on one of the first component and the second component. A slot may be configured to receive the pin on the other of the first component and the second component. In some non-limiting embodiments or aspects, the safety line anchor may also include a gripping arrangement on the first component configured for gripping the safety line in the gripped configuration. In some non-limiting embodiments or aspects, the gripping arrangement may include a bed with an array of grip pins. In some non-limiting embodiments or aspects, the constraining body may define a nesting space between the first and second components and the safety line. The nesting space may be configured to accommodate a traveller during traversal of the traveller along the safety line and across the safety line anchor.

A safety line system, in some non-limiting embodiments or aspects, may include a safety line having a first anchor end and a second anchor end and an intermediate anchor configured for anchoring the safety line between the first anchor end and the second anchor end. The intermediate anchor may include a constraining body having a first component configured to encompass the safety line and a second component slidably mounted relative to the first component. The first component may be movable relative to the second component between a gripped configuration, in which the first component is configured to grip the safety line, and an ungripped configuration, in which the first component is released from gripping the safety line.

In some non-limiting embodiments or aspects, the first anchor end of the safety line may be configured to be anchored to a first support beam and the second anchor end may be configured to be anchored to a second support beam. In some non-limiting embodiments or aspects, the constraining body may be configured to be anchored to an intermediate beam between the first support beam and the second support beam. In some non-limiting embodiments or aspects, the first component may be normally held in the ungripped configuration. In some non-limiting embodiments or aspects, first component may be configured to move relative to the second component from the ungripped configuration to the gripped configuration in response to a force applied to the safety line. In some non-limiting embodiments or aspects, the first component may move linearly relative to the second component between the ungripped configuration and the gripped configuration.

The safety line system, in some non-limiting embodiments or aspects, may also include a guide arrangement configured for guiding a movement of the first component relative to the second component between the ungripped configuration and the gripped configuration. In some non-limiting embodiments or aspects, the guide arrangement may include a pin on one of the first component and the second component and a slot configured to receive the pin on the other of the first component and the second component.

The safety line system, in some non-limiting embodiments or aspects, may also include a gripping arrangement on the first component configured for gripping the safety line in the gripped configuration. In some non-limiting embodiments or aspects, the gripping arrangement may include a bed with an array of grip pins. In some non-limiting embodiments or aspects, the constraining body may define a nesting space between the first and second components and the safety line. The nesting space may be configured to accommodate a traveller during traversal of the traveller along the safety line and across the safety line anchor.

Further non-limiting embodiments or aspects are set forth in the following numbered clauses:

Clause 1: A safety line anchor device arranged to constrain a safety line in order to anchor the safety line to a structure, the anchor device comprising a reconfigurable constraining arrangement which is reconfigurable to a gripping configuration, in which the safety line is gripped by the constraining arrangement, from a non-gripped configuration in which the safety line is constrained by the constraining arrangement, but not gripped.

Clause 2: The safety line anchor device according to clause 1, wherein the constraining arrangement comprises a first component arranged to constrain the safety line, the first component being coupled with a second component which is arranged to be movable with respect to the first component so as to be deployed to grip the safety line.

Clause 3: The safety line anchor device according to clause 1 or 2, wherein the first and second components are normally held in the configuration in which the safety line is constrained by the constraining arrangement, but not gripped.

Clause 4: The safety line anchor device according to any of clauses 1-3, wherein the first and second components are caused to reconfigure to the gripped configuration in the event of a force acting on one of the components.

Clause 5: The safety line anchor device according to any of clauses 1-4, wherein the first and second components move relative to one another translationally (linearly) between the non-gripping and gripping configurations.

Clause 6: The safety line anchor device according to any of clauses 1-5, wherein a guide arrangement is provided to guide the components to move between the non-gripping and gripping configurations.

Clause 7: The safety line anchor device according to any of clauses 1-6, wherein the guide arrangement comprises a slot provided for one of the components and a slider structure (for example a pin) carried by the other of the components for guided movement along the slot.

Clause 8: The safety line anchor device according to any of clauses 1-7, wherein one of the components has a gripping surface and before deployment from the non-gripping configuration to the gripping configuration, the gripping surface is held abeyance from the safety line.

Clause 9: The safety line anchor device according to any of clauses 1-8, further comprising a connection element for connection to a tether, karabiner or other connection element.

Clause 10: The safety line anchor device according to any of clauses 1-9, wherein the connection element is provided on a component that includes a gripping surface to grip the safety line.

Clause 11: The safety line anchor safety line according to any of clauses 1-10, wherein the constraining arrangement comprises a curved structure tapering from a relatively broad root portion to a narrower tip portion, the curved structure defining a boundary around a space within which the diameter of the safety line is received, in use.

Clause 12: The safety line anchor device according to any of clauses 1-11, wherein the constraining arrangement comprises a constraining body.

Clause 13: The safety line anchor device according to any of clauses 1-12, wherein one of the components is mounted within the other of the components.

Clause 14: The safety line anchor device according to any of clauses 1-13, wherein one of the components is mounted within the longitudinal extent of the other component such that it is bounded at either end by the other of the components.

Clause 15: The safety line anchor device according to any of clauses 1-14, wherein the shape and configuration of the constraining arrangement is such that a nesting space is defined dimensioned to accommodate a like shaped and dimensioned traveller, in an inverted position, in the nesting space.

Clause 16: The safety line anchor device according to any of clauses 1-15, wherein the nesting space is defined by one (or both) of the first and second components which has a curved structure tapering from a relatively broad root portion to a narrower tip portion.

Clause 17: A safety line system comprising an anchor device according to any of clauses 1-16, the anchor device having a connection formation for securing to an anchor point, and a nesting space is defined by a component which has a curved/curled structure tapering from a relatively broad root portion to a narrower tip portion; a safety line traveller having a safety line encompassing structure which is shaped and configured complementarily to the curved/curled component of the anchor device, such that the traveller can pass through the nesting space of the anchor device.

Clause 18: An intermediate anchor system for a height safety application; the system comprising an anchor device according to any of clauses 1-17, and means for connecting the anchor device to a pre-existing structure.

Clause 19: A safety line anchor configured for constraining an intermediate portion of a safety line, the safety line anchor comprising: a constraining body having a first component configured to encompass the safety line and a second component slidably mounted relative to the first component, wherein the first component is movable relative to the second component between a gripped configuration, in which the first component is configured to grip the safety line, and an ungripped configuration, in which the first component is released from gripping the safety line.

Clause 20: The safety line anchor according to clause 19, wherein the first component is normally held in the ungripped configuration.

Clause 21: The safety line anchor according to clause 19 or 20, wherein first component is configured to move relative to the second component from the ungripped configuration to the gripped configuration in response to a force applied to the safety line.

Clause 22: The safety line anchor according to any of clauses 19-21, wherein the first component moves linearly relative to the second component between the ungripped configuration and the gripped configuration.

Clause 23: The safety line anchor according to any of clauses 19-22, further comprising a guide arrangement configured for guiding a movement of the first component relative to the second component between the ungripped configuration and the gripped configuration.

Clause 24: The safety line anchor according to any of clauses 19-23, wherein the guide arrangement comprises a pin on one of the first component and the second component and a slot configured to receive the pin on the other of the first component and the second component.

Clause 25: The safety line anchor according to any of clauses 19-24, further comprising a gripping arrangement on the first component configured for gripping the safety line in the gripped configuration.

Clause 26: The safety line anchor according to any of clauses 19-25, wherein the gripping arrangement comprises a bed with an array of grip pins.

Clause 27: The safety line anchor according to any of clauses 19-26, wherein the constraining body defines a nesting space between the first and second components and the safety line, and wherein the nesting space is configured to accommodate a traveller during traversal of the traveller along the safety line and across the safety line anchor.

Clause 28: A safety line system, comprising a safety line having a first anchor end and a second anchor end; and an intermediate anchor configured for anchoring the safety line between the first anchor end and the second anchor end, the intermediate anchor comprising: a constraining body having a first component configured to encompass the safety line and a second component slidably mounted relative to the first component, wherein the first component is movable relative to the second component between a gripped configuration, in which the first component is configured to grip the safety line, and an ungripped configuration, in which the first component is released from gripping the safety line.

Clause 29: The safety line system according to clause 28, wherein the first anchor end of the safety line is configured to be anchored to a first support beam; and wherein the second anchor end is configured to be anchored to a second support beam.

Clause 30: The safety line system according to clause 28 or 29, wherein the constraining body is configured to be anchored to an intermediate beam between the first support beam and the second support beam.

Clause 31: The safety line system according to any of clauses 28-30, wherein the first component is normally held in the ungripped configuration.

Clause 32: The safety line system according to any of clauses 28-31, wherein first component is configured to move relative to the second component from the ungripped configuration to the gripped configuration in response to a force applied to the safety line.

Clause 33: The safety line system according to any of clauses 28-32, wherein the first component moves linearly relative to the second component between the ungripped configuration and the gripped configuration.

Clause 34: The safety line system according to any of clauses 28-33, further comprising a guide arrangement configured for guiding a movement of the first component relative to the second component between the ungripped configuration and the gripped configuration.

Clause 35: The safety line system according to any of clauses 28-34, wherein the guide arrangement comprises a pin on one of the first component and the second component and a slot configured to receive the pin on the other of the first component and the second component.

Clause 36: The safety line system according to any of clauses 28-35, further comprising a gripping arrangement on the first component configured for gripping the safety line in the gripped configuration.

Clause 37: The safety line system according to any of clauses 28-36, wherein the gripping arrangement comprises a bed with an array of grip pins.

Clause 38: The safety line system according to any of clauses 28-37, wherein the constraining body defines a nesting space between the first and second components and the safety line, and wherein the nesting space is configured to accommodate a traveller during traversal of the traveller along the safety line and across the safety line anchor.

These and other features and characteristics of the non-limiting embodiments or aspects described herein will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only.

### BRIEF DESCRIPTION OF THE DRAWINGS

The present disclosure will now be further described, by way of non-limiting embodiments or aspects, with reference to the accompanying drawings, in which:

FIG. 1 is a schematic perspective view of a safety line system in accordance with some non-limiting embodiments or aspects of the present disclosure;

FIG. 2 is a perspective view of the safety line system of FIG. 1;

FIG. 3 is a top view of the safety line system of FIG. 1;

FIG. 4 is a perspective view of a non-limiting embodiment or aspect of a safety system in accordance with the present disclosure;

FIG. 5 is a detailed perspective view of the safety system of FIG. 4;

FIG. 6 is a schematic cut-away perspective view of a part of an anchor of the safety system of FIGS. 4-5;

FIG. 7 is a plane view of the cross-section shown in FIG. 6 in a first orientation;

FIG. 8 is a plane view corresponding to that of FIG. 7, but in an alternate configuration;

FIG. 9 is a perspective view of a part of the anchor of the safety system in accordance with some non-limiting embodiments or aspects of the present disclosure;

FIGS. 10A and 10B are side views of the part of the anchor system in alternate configurations;

FIG. 11 is a perspective view of a part of an anchor system mounted to the safety line;

FIGS. 12A and 12B are exploded views (plane and end) of the components of a constraining body of the safety system in accordance with some embodiments or aspects of the present disclosure; and

FIG. 13 is an explanatory view showing a traveller passing via the anchor system in place.

### DETAILED DESCRIPTION

As used herein, the singular form of “a”, “an”, and “the” include plural referents unless the context clearly dictates otherwise. Spatial or directional terms, such as “left”, “right”, “inner”, “outer”, “above”, “below”, and the like, relate to the embodiments or aspects as shown in the drawing figures and are not to be considered as limiting as the embodiments or aspects can assume various alternative orientations. All numbers used in the specification and claims are to be understood as being modified in all instances by the term “about”. By “about” is meant within plus or minus twenty-five percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements. All documents referred to herein are “incorporated by reference” in their entirety. The term “at least” is synonymous with “greater than or equal to”. As used herein, “at least one of” is synonymous with “one or more of”. For example, the phrase “at least one of A, B, or C” means any one of A, B, or C, or any combination of any two or more of A, B, or C. For example, “at least one of A, B, and C” includes A alone; or B alone; or C alone; or A and B; or A and C; or B and C; or all of A, B, and C.

The word “comprising” and “comprises”, and the like, does not exclude the presence of elements or steps other than those listed in any claim or the specification as a whole. In the present specification, “comprises” means “includes” and “comprising” means “including”. As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values. As used herein, the terms “perpendicular”, “transverse”, “substantially perpendicular”, or “substantially transverse” mean a relative angle as between two objects at their real or theoretical intersection is from 85° to 90°, or from 87° to 90°, or from 88° to 90°, or from 89° to 90°, or from 89.5° to 90°, or from 89.75° to 90°, or from 89.9° to 90°, inclusive of the recited values.

The discussion of various embodiments or aspects may describe certain features as being “particularly” or “preferably” within certain limitations (e.g., “preferably”, “more preferably”, or “even more preferably”, within certain limitations). It is to be understood that the disclosure is not limited to these particular or preferred limitations but encompasses the entire scope of the various embodiments and aspects described herein. The disclosure comprises, consists of, or consists essentially of, the following embodiments or aspects, in any combination. Various embodiments or aspects of the disclosure are illustrated in separate drawing figures. However, it is to be understood that this is simply for ease of illustration and discussion. In the practice of the disclosure, one or more embodiments or aspects shown in one drawing figure can be combined with one or more embodiments or aspects shown in one or more of the other drawing figures.

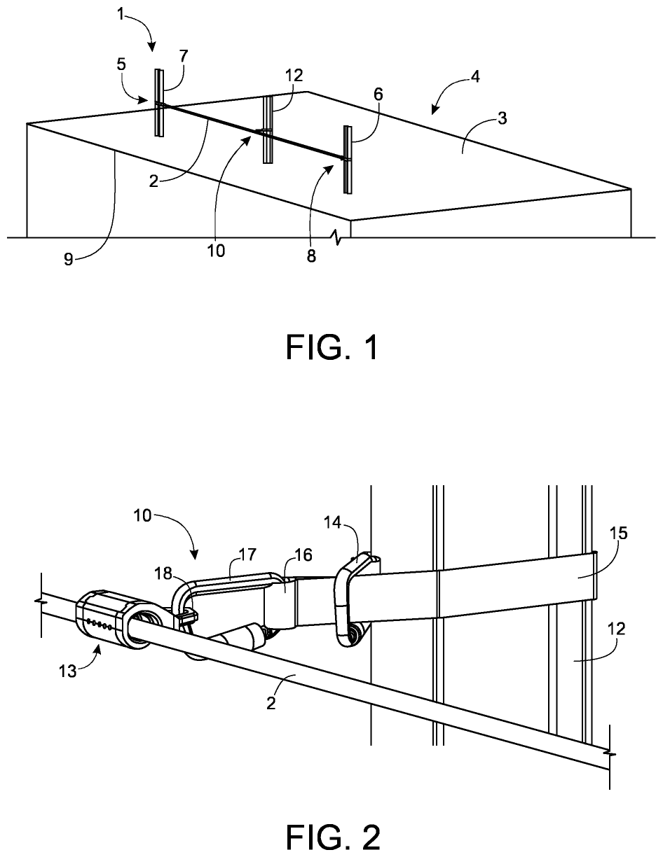

It will be appreciated that FIGS. 1-13 are schematic illustrations and so features shown therein are not drawn to scale.

Referring to the drawings, and initially to FIG. 1, there is shown a temporary safety line system 1 for working at height in accordance with some non-limiting embodiments or aspects of the present disclosure. The safety system 1 includes a safety line 2 which is anchored at each end, 7, 8 to a respective support beam 5, 6 positioned on the roof 3 of a building 4. The use of temporary safety lines is prevalent in the working at height industry, and safety lines 2 are strung between pre-existing structures present on a building or other structure, in this case the beams 5, 6 that are present on the roof 3. If safety line ends 7, 8 were the only anchor points then there is a risk that a person working at height could fall over the edge 9 of the building, pulling the safety line 2 sideways. The span of safety line 2 therefore needs to be limited, in order to prevent this from occurring. The present disclosure is particularly suited to such temporary safety lines and provides an intermediate anchor system 10 for anchoring the safety line 2 at a point between the ends 7, 8. This ensures that the lateral sideways deflection of the safety line 2 is limited by the presence of the intermediate anchor system 10. In the example shown, the intermediate anchor system is shown mounted to an intermediate pre-existing beam 12 that is present on the roof 3.

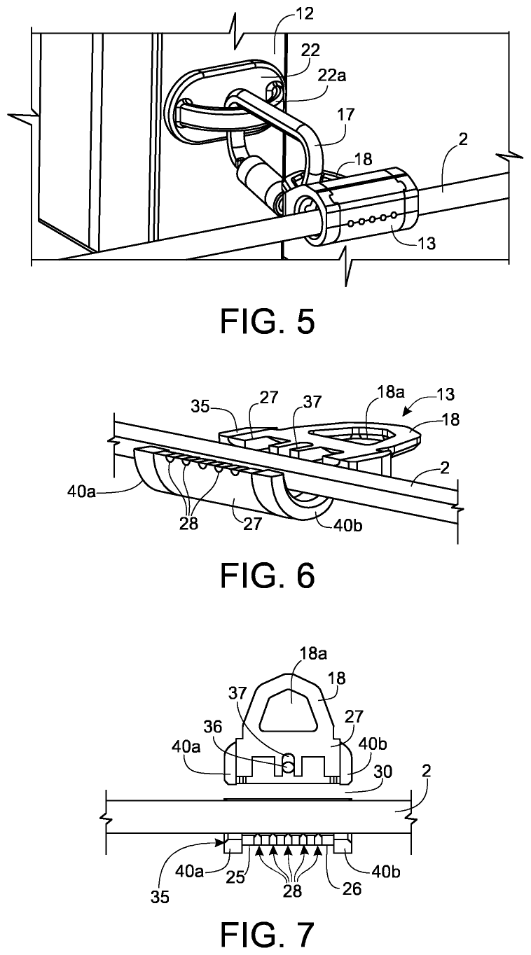

In some non-limiting embodiments or aspects, such as shown in FIG. 2, the intermediate anchor system 10 includes a constraining body 13 which encompasses and constrains the safety line 2. In some non-limiting embodiments or aspects, the constraining body 13 is secured to the beam 12 by means of a belt strap 15 which is looped around the beam 12, passing through a frame gate 14 at one terminal end of the belt strap, and which has a termination loop 16 at the other end to which a karabiner 17 is fixed. The karabiner 17 is secured through a connection part 18 of the constraining body 13. In some non-limiting embodiments or aspects, such as shown in FIGS. 4 and 5, the constraining body 13 is secured to the beam 12 by means of a plate 22 fixed to the beam. The plate 22 has a connection spar 22a for connection to the karabiner 17.

The constraining body 13 is shown most clearly in isolation in FIGS. 6-12 in accordance with various non-limiting embodiments or aspects of the present disclosure. With reference to FIG. 9, the constraining body 13 includes a guide hand portion 20 that in use curves around the safety line 2, tapering from a root portion 20a, to a terminal end tip 20b. In some non-limiting embodiments or aspects, the guide hand portion 20 provides a channel 30 through which the safety line 2 can extend. When initially installed, the constraining body 13 does not grip the body but simply acts as a constraining barrier. In the event of a user fall (which would potentially see the safety line being pulled laterally toward the building edge 9), the constraining body 13 reconfigures to grip the safety line and prevent the safety line being pulled through the constraining body 13.

FIG. 10A shows the constraining body 13 with the safety line 2 extending through the guide hand portion 20. A gap 21 can be seen between the safety line 2 and the constraining internal surface of the curled guide hand portion 20 of the constraining body. FIG. 10B shows the constraining body 13 reconfigured to the gripping configuration in which a gripping element 25 is advanced from a retracted position to engage with the outer surface of the safety line 2.

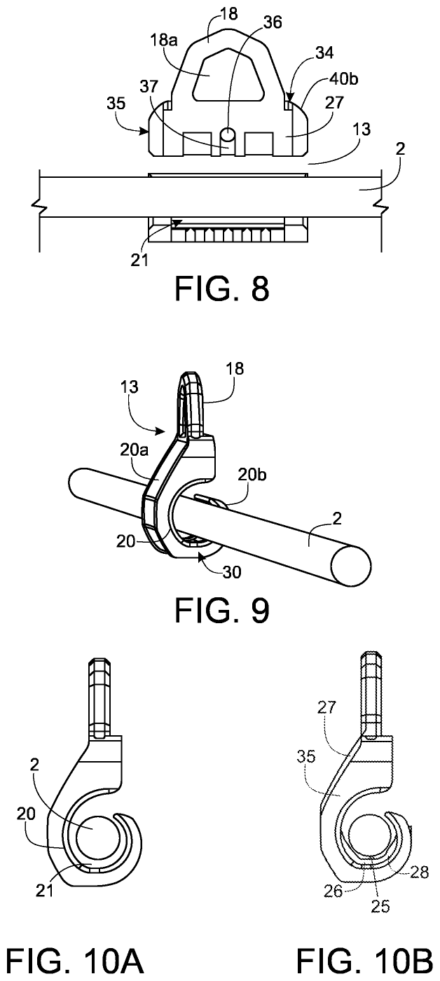

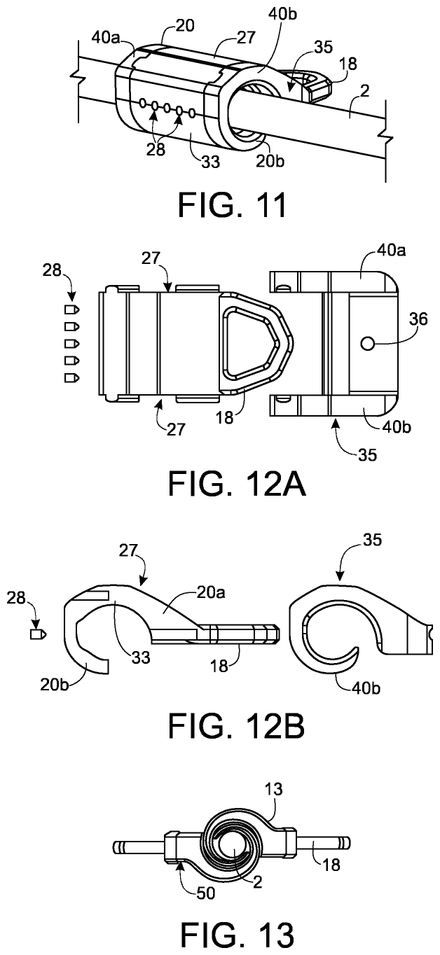

In some non-limiting embodiments or aspects, such as shown in FIGS. 7-8, the constraining body 13 includes two components 27, 35 mounted together. The first component 27 includes the connection part 18 at one side thereof and carries at an opposed side the gripping element 25. In some non-limiting embodiments or aspects, the gripping element 25 includes a bed 26 carrying an array of grip pins 28 which project inwardly towards the channel 30 within which the safety line 2 is to be constrained. In some non-limiting embodiments or aspects, such as shown in FIG. 11, the first component 27 includes a curved hand portion 33 making up the guide hand portion 20 of the overall constraining body 13.

In some non-limiting embodiments or aspects, the first component 27 is slidably mounted with respect to the second component 35. Pin 36, shown in FIGS. 7-8, is fixed in position on the second component 35, and slides within a guide slot 37 provided in the first component 27 and limits relative sliding movement of the first and second components 27, 35 making up the overall constraining body 13. In some non-limiting embodiments or aspects, the second component 35 includes opposed end portions 40a, 40b having curled fingers which are positioned at either end of the second component 27. The end portions 40a, 40b are curved correspondingly to the curved hand portion 33 and together with this make up the guide hand portion 20 of the overall constraining body 13.

The first and second components 27, 35 are shown in exploded view in FIGS. 12A and 12B. FIGS. 7-8 show the first and second components 27, 35 in the two extremes of sliding positions. In FIG. 8, the first and second components 27, 35 of the constraining body 13 are shown in the non-gripping configuration of the anchor. The gap 21 between the constraining member 13 and the safety line 2 can be seen. In FIG. 7, the first component 27 is moved to the advanced position (with respect to the second component 35) in which the gripping element 25 is engaged with the safety line 2, and the grip pins 28 bite into the safety line 2. FIG. 8 shows the components 27, 35 arranged in the situation of FIG. 10A in which the gap 21 is present and the safety line 2 is not gripped. In this condition there is a recessed shoulder 34 between the components 27, 35. FIG. 7 shows the situation in which the grip pins 28 are engaged with the safety line 2. In this condition, the gap 21 is no longer present.

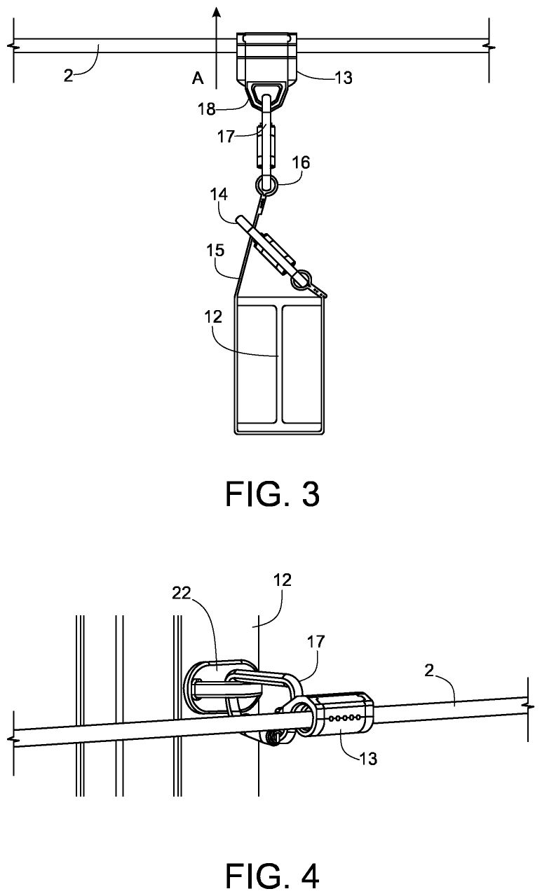

In the event of a fall, the safety line 2 is pulled away from the anchor point (direction of arrow A in FIG. 3). This causes the second component 35 to be moved in the same direction (direction of arrow A) because the surfaces of the fingers 40, 40b are contacted by the pulled safety line 2. The second component 27 is however fixed to the anchor point by the connected karabiner 17 and strap belt 15 and consequently cannot move in the direction of arrow A as the safety line 2 is pulled outwardly. This causes relative movement and reconfiguration of the first and second components 27, 35 from the non-gripping configuration to the gripping configuration.

In some non-limiting embodiments or aspects, a further feature of the arrangement is the ability for the system to be used to provide an intermediate anchor system for a lifeline (particularly a temporary lifeline) providing the ability for a safety line traveller 50 mounted to the safety line 2 to pass through the intermediate anchor position (from one side to the other) without the need for the user to disengage and re-engage the traveller 50 on either side of the intermediate anchor point. This is achieved by means of the traveller 50 being shaped, dimensioned and configured correspondingly to the curved tapering hand portion 20 of the constraining device 13, as shown in FIG. 13. The traveller 50 is shown as having a curved tapering profile corresponding to the curved tapering hand portion 20 of the constraining device 13. The shape and configuration of the constraining arrangement is such that a nesting space is defined by the curved tapering hand portion 20 of the constraining device 13, which dimensioned to accommodate the like shaped and dimensioned traveller 50, in an inverted position, in the nesting space.

When acting as an intermediate attachment, when the safety line 2 is pulled away from the anchorage the grip pins 28 engage with the safety line 2, preventing the safety line 2 from pulling through the intermediate anchor system 10 (given the system 10 is mounted half way along the system) which halves the amount of the safety line 2 stretch the system has. Therefore the user falls a lesser distance (if at all), exposing them to fewer hazards and enabling them to work in lower fall clearance applications.

It should be noted that the above-mentioned non-limiting embodiments or aspects illustrate rather than limit the disclosure, and that those skilled in the art will be capable of designing many alternative embodiments or aspects without departing from the scope of the disclosure as defined by the appended claims. In the claims, any reference signs placed in parentheses shall not be construed as limiting the claims. The mere fact that certain measures are recited in mutually different dependent claims does not indicate that a combination of these measures cannot be used to advantage.

1-58. (canceled)

59. A safety line anchor configured for constraining an intermediate portion of a safety line, the safety line anchor comprising:
a constraining body having a first component configured to encompass the safety line and a second component slidably mounted relative to the first component,
wherein the first component is movable relative to the second component between a gripped configuration, in which the first component is configured to grip the safety line, and an ungripped configuration, in which the first component is released from gripping the safety line.

60. The safety line anchor according to claim 59, wherein the first component is normally held in the ungripped configuration.

61. The safety line anchor according to claim 60, wherein first component is configured to move relative to the second component from the ungripped configuration to the gripped configuration in response to a force applied to the safety line.

62. The safety line anchor according to claim 59, wherein the first component moves linearly relative to the second component between the ungripped configuration and the gripped configuration.

63. The safety line anchor according to claim 59, further comprising a guide arrangement configured for guiding a movement of the first component relative to the second component between the ungripped configuration and the gripped configuration.

64. The safety line anchor according to claim 63, wherein the guide arrangement comprises a pin on one of the first component and the second component and a slot configured to receive the pin on the other of the first component and the second component.

65. The safety line anchor according to claim 59, further comprising a gripping arrangement on the first component configured for gripping the safety line in the gripped configuration.

66. The safety line anchor according to claim 65, wherein the gripping arrangement comprises a bed with an array of grip pins.

67. The safety line anchor according to claim 59, wherein the constraining body defines a nesting space between the first and second components and the safety line, and wherein the nesting space is configured to accommodate a traveller during traversal of the traveller along the safety line and across the safety line anchor.

68. A safety line system, comprising:
a safety line having a first anchor end and a second anchor end; and
an intermediate anchor configured for anchoring the safety line between the first anchor end and the second anchor end, the intermediate anchor comprising:
a constraining body having a first component configured to encompass the safety line and a second component slidably mounted relative to the first component,
wherein the first component is movable relative to the second component between a gripped configuration, in which the first component is configured to grip the safety line, and an ungripped configuration, in which the first component is released from gripping the safety line.

69. The safety line system according to claim 68, wherein the first anchor end of the safety line is configured to be anchored to a first support beam; and wherein the second anchor end is configured to be anchored to a second support beam.

70. The safety line system according to claim 69, wherein the constraining body is configured to be anchored to an intermediate beam between the first support beam and the second support beam.

71. The safety line system according to claim 68, wherein the first component is normally held in the ungripped configuration.

72. The safety line system according to claim 71, wherein first component is configured to move relative to the second component from the ungripped configuration to the gripped configuration in response to a force applied to the safety line.

73. The safety line system according to claim 68, wherein the first component moves linearly relative to the second component between the ungripped configuration and the gripped configuration.

74. The safety line system according to claim 68, further comprising a guide arrangement configured for guiding a movement of the first component relative to the second component between the ungripped configuration and the gripped configuration.

75. The safety line system according to claim 74, wherein the guide arrangement comprises a pin on one of the first component and the second component and a slot configured to receive the pin on the other of the first component and the second component.

76. The safety line system according to claim 68, further comprising a gripping arrangement on the first component configured for gripping the safety line in the gripped configuration.

77. The safety line system according to claim 76, wherein the gripping arrangement comprises a bed with an array of grip pins.

78. The safety line system according to claim 68, wherein the constraining body defines a nesting space between the first and second components and the safety line, and wherein the nesting space is configured to accommodate a traveller during traversal of the traveller along the safety line and across the safety line anchor.
